(19) United States
(12) Patent Application Publication
(10) Pub. No.: US 2015/0001415 A1
(43) Pub. Date: Jan. 1, 2015

(54) ELECTROSTATIC PROTECTION STRUCTURE FOR PIXEL UNIT AND IMAGE SENSOR

(71) Applicants: Tianma Micro-Electronics Co., Ltd., Shenzhen (CN); Shanghai Tianma Micro-Electronics Co., Ltd., Shanghai (CN)

(72) Inventors: Xiaolei FEI, Shanghai (CN); Yan Ling, Shanghai (CN); Hong Zhu, Shanghai (CN); Gang Qi, Shanghai (CN)

(73) Assignees: Tianma Micro-Electronics Co., Ltd., Shenzhen (CN); Shanghai Tianma Micro-Electronics Co., Ltd., Shanghai (CN)

(21) Appl. No.: 14/165,435

(22) Filed: Jan. 27, 2014

(30) Foreign Application Priority Data
Jun. 28, 2013 (CN) 201310270706.5

(51) Int. Cl. H05F 3/00; G01T 1/17

(52) U.S. Cl. CPC H05F 3/00; G01T 1/17
USPC 250/394; 361/220

(57) ABSTRACT

An electrostatic protection structure is disclosed. One inventive aspect is an electrostatic protection structure. The electrostatic protection structure includes a data line, adapted to transmit a pixel signal, where the data line includes an electrostatic diverting path. The electrostatic protection structure also includes a signal transmission path, where a first terminal of the signal transmission path is connected to a pixel unit, and a second terminal of the signal transmission path is connected to a signal output terminal, where the second terminal is configured to output a signal from the pixel unit. A first terminal of the electrostatic diverting path is connected to a constant potential, and a second terminal of the electrostatic diverting path is connected to the signal output terminal, and the impedance of the signal transmission path is greater than the impedance of the electrostatic diverting path.

### CROSS-REFERENCES TO RELATED APPLICATIONS

This application claims the benefit of priority to Chinese Patent Application No. 201310270706.5, filed with the Chinese Patent Office on Jun. 28, 2013 and entitled “ELECTROSTATIC PROTECTION STRUCTURE FOR PIXEL UNIT AND IMAGE SENSOR”, the contents of which is incorporated herein by reference in its entirety.

### FIELD OF THE INVENTION

The present invention relates to the field of electrostatic protection, and in particular to an electrostatic protection structure which may prevent electrostatic damage and an image sensor using the electrostatic protection structure.

### BACKGROUND OF THE INVENTION

With the development of society and continual progress of science and technology, kinds of digital imaging medical technologies emerge in endlessly. Digital imaging technologies have played a very important role in the present medical field. In most of the existing digital imaging medical applications, such as the Chest X-ray and the Computerized Tomography (CT), an element which is crucial in the digital imaging technology is an X-ray sensor.

The operation principle of the X-ray sensor is as follows: a visible light is generated when an X-ray passes through a scintillator layer or a fluorescent layer, and the visible light is converted into a charge by a photodiode in a pixel unit. The charge is stored in the photodiode. A voltage is applied line by line to scan lines in a pixel array by an address control unit, thus pixel switches connected to the scan lines are turned on line by line. The charge stored in the photodiode is output to a data processing unit via a data line. The data processing unit may further process the obtained electrical signal. For example, the data processing unit may amplify and perform the analog-digital conversion on the obtained electrical signal. Finally, image information is obtained.

During the binding manufacturing process of the X-ray sensor, static electricity may enter a display area from the signal output terminal of the date line, thereby damaging a pixel unit in the display area.

FIG. 1a is a plan structural schematic diagram of an electrostatic protection structure in the existing X-ray image sensor, and FIG. 1b is an enlarged diagram of the electrostatic capacitor protection structure in FIG. 1a. Referring to FIG. 1a and FIG. 1b, the method for preventing the pixel unit from electrostatic damage applied in the prior art is as follows. A pixel (dummy pixel) protection electrode 2 is provided in the non-display area, and is in cooperation with an electrostatic protection capacitor structure 1 provided at a date line. The electrostatic protection capacitor structure 1 includes a data line 11 which includes a signal output terminal 111 and a pixel unit connection terminal 112. A pixel unit transmits a pixel signal to the signal output terminal 111 via the pixel unit connection terminal 112 and the data line 11. In addition, an electrostatic protection capacitor 12 is provided at a branch of the data line 11, and one terminal of the electrostatic protection capacitor 12 is connected to a constant potential. In this design, the static electricity is firstly desired to be diverted into the electrostatic protection capacitor. Moreover, if a part of the static electricity passes through the signal transmission path, the part of the static electricity may still be firstly transmitted into the pixel protection electrode 2, thus the pixel electrode in the display area is prevented from electrostatic damage. However, the effect of electrostatic protection is not ideal.

### BRIEF SUMMARY OF THE INVENTION

One inventive aspect is an electrostatic protection structure. The electrostatic protection structure includes a data line, adapted to transmit a pixel signal, where the data line includes an electrostatic diverting path. The electrostatic protection structure also includes a signal transmission path, where a first terminal of the signal transmission path is connected to a pixel unit, and a second terminal of the signal transmission path is connected to a signal output terminal, where the second terminal is configured to output a signal from the pixel unit. A first terminal of the electrostatic diverting path is connected to a constant potential, and a second terminal of the electrostatic diverting path is connected to the signal output terminal, and the impedance of the signal transmission path is greater than the impedance of the electrostatic diverting path.

Another inventive aspect is an X-ray image sensor. The X-ray image sensor includes a plurality of pixel units, and an electrostatic protection structure connected to the pixel units. The electrostatic protection structure includes a data line, adapted to transmit a pixel signal, where the data line includes an electrostatic diverting path. The electrostatic protection structure also includes a signal transmission path, where a first terminal of the signal transmission path is connected to a pixel unit, and a second terminal of the signal transmission path is connected to a signal output terminal, where the second terminal is configured to output a signal from the pixel unit. A first terminal of the electrostatic diverting path is connected to a constant potential, and a second terminal of the electrostatic diverting path is connected to the signal output terminal, and the impedance of the signal transmission path is greater than the impedance of the electrostatic diverting path.

### BRIEF DESCRIPTION OF THE DRAWINGS

In order to explain the technical solutions in embodiments of the present invention more clearly, drawings accompanying the embodiments are briefly illustrated hereinafter. Apparently, the accompanying drawings described hereinafter are only for some embodiments of the present invention, and those skilled in the art can further conceive other drawings according to the drawings without creative work.

FIG. 1a is a schematic top view of an electrostatic protection structure in a X-ray image sensor in the prior art;

FIG. 1b is an enlarged diagram of the electrostatic capacitor protection structure in FIG. 1a.

FIG. 1c is an equivalent circuit diagram of the electrostatic protection structure shown in FIG. 1b;

FIG. 2 is a schematic diagram of an electrostatic protection structure in an X-ray image sensor according to a first embodiment of the present invention; and

FIG. 3 is a schematic diagram of an electrostatic protection structure in an X-ray image sensor according to a second embodiment of the present invention.

### DETAILED DESCRIPTION OF THE INVENTION

The technical solutions according to the embodiments of the present invention will be described clearly and completely as follows in conjunction with the accompany drawings in the embodiments of the present invention. It is clear that the described embodiments are only a part of the embodiments according to the present invention, but not all of the embodiments according to the present invention. All the other embodiments obtained by those skilled in the art based on the embodiments in the present invention without any creative work belong to the scope of the present invention.

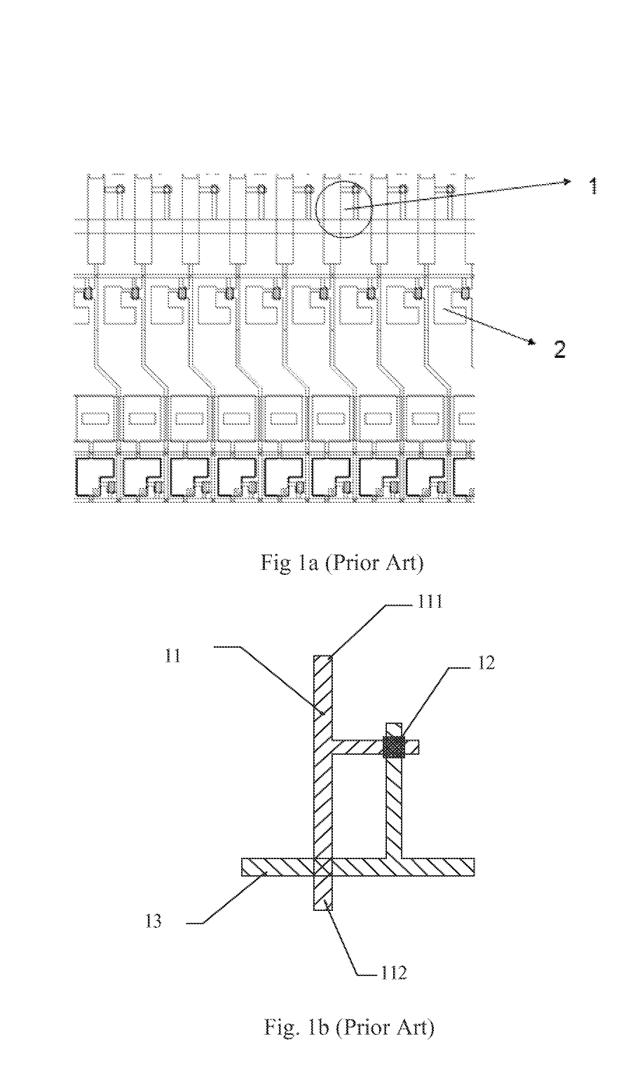

FIG. 1c shows an equivalent circuit diagram of an electrostatic protection structure in the prior art shown in FIG. 1b. A path 1 is a signal transmission path and a path 2 is an electrostatic diverting path. The equivalent impedance of the path 1 is a line resistance R1 of the data line, and the equivalent impedance of the path 2 is the sum of a line resistance R2 of the data line and an additional inductive impedance and capacitive impedance which are generated due to the bending of the path 2. Thus, the equivalent impedance of the path 2 is larger than the equivalent impedance of the path 1. It is discovered by the inventor of the present invention after numerous experiments that: even if an electrostatic protection capacitor 12 is provided and a pixel protection electrode 2 is added, in the case where the static electricity flows into the data line, the overlapping portion between a common electrode and the data line in the outermost region of the display area, rather than the electrostatic protection capacitor 12 and the pixel protection electrode 2, may firstly suffer from the electrostatic breakdown, thereby causing the data line to be broken and affecting the normal operation of the X-ray image sensor. To this, the applicant proposes the following solution. The impedance of the signal transmission path is provided to be larger than the impedance of the electrostatic diverting path in the data line, thus even if the static electricity flows into the data line during the binding manufacturing process of the X-ray image sensor, the static electricity may still be preferentially diverted out via the electrostatic diverting path, thereby preventing the operating circuit from the electrostatic damage.

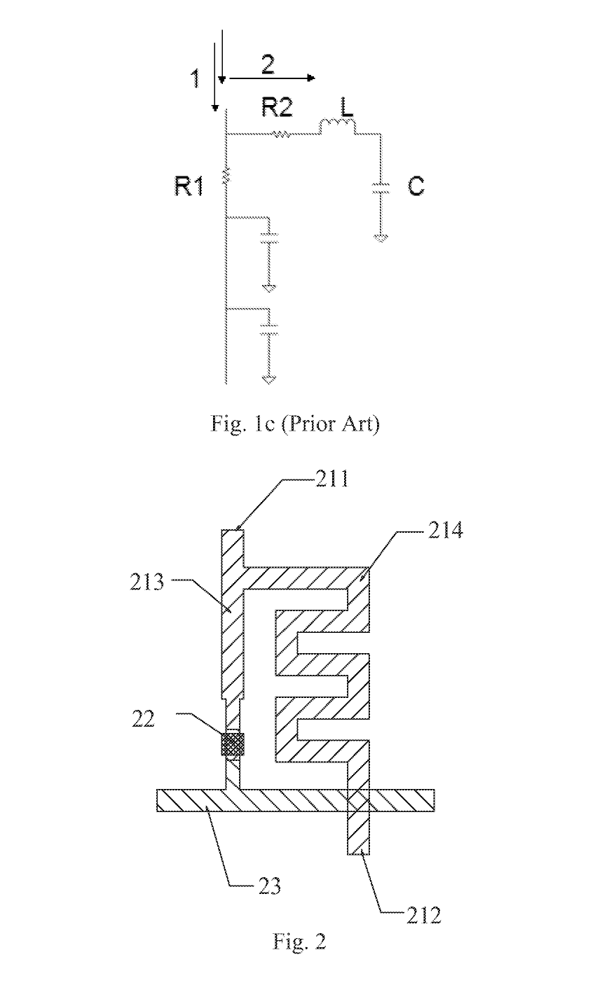

The embodiments of the present invention are described below in conjunction with the accompanying drawings. FIG. 2 is a schematic diagram of an electrostatic protection structure in an X-ray image sensor according to a first embodiment of the present invention. The electrostatic protection structure includes a data line. The data line includes a signal transmission path 214 and an electrostatic diverting path 213. The data line includes a pixel unit connection terminal 212 and a signal output terminal 211. One terminal of the signal transmission path 214 is connected to the pixel unit via the pixel unit connection terminal 212, and the other terminal of the signal transmission path 214 is connected to the signal output terminal 211. One terminal of the electrostatic diverting path 213 is connected to the signal output terminal 211, and the other terminal of the electrostatic diverting path 213 is connected to a constant potential, to divert static electricity. In order to ensure that the static electricity can be diverted via the electrostatic diverting path 213, the impedance of the electrostatic diverting path 213 is provided to be less than that of the signal transmission path 214 in the present invention.

In one embodiment, the electrostatic diverting path 213 includes a straight section, and the signal transmission path 214 includes a bending section. When static electricity is generated, the impedance of the bending section is equivalent to the sum of linear resistance and the inductive impedance (2πfL) generated due to the bending, and the impedance of the straight section only includes the linear resistance. Therefore, the impedance of the electrostatic diverting path 213 being less than the impedance of the signal transmission path 214 is realized.

It should be noted that, although the inductance impedance generated due to the bending of the path is less in the case of the normal operation, the additional inductive impedance caused by the high frequency characteristic of the extremely short discharge time is not ignorable in the case of instant electrostatic discharge.

Furthermore, an electrostatic protection capacitor 22 is provided in the electrostatic diverting path 213. One polar plate of the electrostatic protection capacitor 22 is connected to a constant potential via a wire 23, to divert the static electricity to the constant potential. The other polar plate of the electrostatic protection capacitor 22 is connected to the signal output terminal 211 via a data line in the electrostatic diverting path 213, to further reduce the impedance of the electrostatic diverting path 213. In one embodiment, the wire 23 is a wire in a gate electrode layer. The constant potential may be the ground potential, that is to say, one polar plate of the electrostatic protection capacitor 22 may be connected to the signal output terminal 211 of the data line, and the other polar plate of the electrostatic protection capacitor 22 may be grounded via the wire 23.

It should be noted that, multiple electrostatic protection capacitors 22 may be connected in parallel in the electrostatic diverting path 213 as required, to avoid a failure of the electrostatic protection structure caused by a uniquely provided electrostatic protection capacitor being broken down by the static electricity. By providing the multiple electrostatic protection capacitors in parallel, the efficacy of the electrostatic protection structure may be effectively improved.

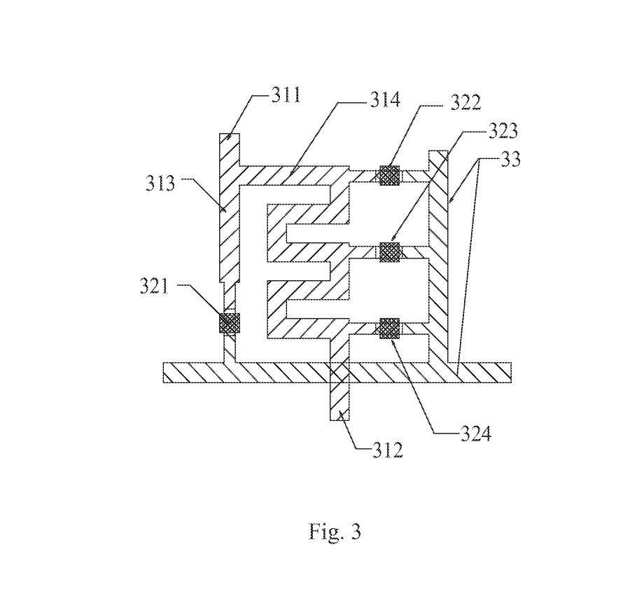

FIG. 3 shows a schematic diagram of an electrostatic protection structure in an X-ray image sensor according to a second embodiment of the present invention. In the present embodiment, a signal transmission path 314 includes 9 bending points, that is to say, the signal transmission path 314 is connected to a pixel unit via a pixel unit connection terminal 312 after 9 times of bending. In the present embodiment, electrostatic protection capacitors 322, 323 and 324 are provided at the different bending points of the signal transmission path 314 respectively. Similar to an electrostatic protection capacitor 321 provided in an electrostatic diverting path 313, the electrostatic protection capacitors 322, 323 and 324 are connected to a constant potential. In one embodiment, one polar plate of one or more of the electrostatic protection capacitors 321, 322, 323 and 324 is connected to a constant potential via a wire 33 located in the same layer as a gate electrode. The constant potential may be the ground potential to divert the static electricity to a ground terminal.

Similar to the above-mentioned embodiment, multiple electrostatic protection capacitors may be provided in the electrostatic diverting path, which are respectively connected in parallel with the electrostatic protection capacitors 321, 322, 323 and 324, to further improve the efficiency of electrostatic protection.

In another embodiment of the present invention, the signal transmission path portion and the electrostatic diverting path portion of the data line may be made of materials with different resistivities to achieve the fact that the impedance of the signal transmission path is larger than the impedance of the electrostatic diverting path. Similar to the above-mentioned embodiment, an electrostatic protection capacitor may be provided in the electrostatic diverting path to further reduce the impedance of the electrostatic diverting path, thus more static electricity is transmitted to the electrostatic diverting path, thereby reducing the damage to a working component due to the static electricity passing through the signal transmission path.

In one embodiment, two polar plates of the electrostatic protection capacitor according to various embodiments of the present invention are a gate electrode layer and a source drain electrode layer respectively, and the intermediate medium of the electrostatic protection capacitor is an active layer. The material of the active layer is an amorphous silicon film.

In another embodiment, two polar plates of the electrostatic protection capacitor according to various embodiments of the present invention are a source drain electrode layer and a common electrode layer respectively, and the intermediate medium of the electrostatic protection capacitor is a passivation layer. The material of the common electrode layer is Indium Tin Oxide (ITO) and the material of the passivation layer is SiNx.

Furthermore, the electrostatic protection capacitor provided by an embodiment of the present invention may further include a dummy pixel protection unit. The dummy pixel protection unit is provided between the signal transmission path and the pixel unit, to further ensure the electrostatic protection.

In addition, an embodiment of the present invention further provides an X-ray image sensor including the above-mentioned electrostatic protection structure. The X-ray image sensor further includes multiple pixel units. The electrostatic protection structure is connected to a pixel unit in a display area of the X-ray image sensor, and the signal output from the pixel unit is output via the electrostatic protection structure. During the manufacturing process of the X-ray image sensor, in the case where the static electricity enters from the signal output terminal, the static electricity is diverted out by the electrostatic protection structure, thereby preventing the pixel unit or other component from electrostatic damage. It should be noted that, one electrostatic protection structure may be connected to multiple pixel units, and alternatively one electrostatic protection structure may be connected to one pixel unit.

The advantages or beneficial effects of embodiments of the present invention are as follows.

The data line connected to the pixel unit has two portions, namely, the signal transmission path and the electrostatic diverting path. One terminal of the signal transmission path is connected to the pixel unit, and the other terminal of the signal transmission path is connected to the signal output terminal. One terminal of the electrostatic diverting path is connected to the signal output terminal, and the other terminal of the electrostatic diverting path is connected to the constant potential. Moreover, the impedance of the signal transmission path is provided larger than that of the electrostatic diverting path, thus the static electricity can be directly diverted out via the electrostatic diverting path in the case where the static electricity flows into the data line from the signal output terminal, thereby protecting the pixel unit connected to the signal transmission path from the electrostatic damage.

The embodiments described above are not for limiting the scope of protection of the technical solution. Any changes, equivalent substitutions, improvements and so on made within the spirit and principle of the above-mentioned embodiments are all contained in the scope of protection of the technical solution.

What is claimed is:

1. An electrostatic protection structure, comprising:
a data line, adapted to transmit a pixel signal, wherein the data line comprises:
an electrostatic diverting path, and
a signal transmission path,
wherein a first terminal of the signal transmission path is connected to a pixel unit, and a second terminal of the signal transmission path is connected to a signal output terminal, wherein the second terminal is configured to output a signal from the pixel unit,
wherein a first terminal of the electrostatic diverting path is connected to a constant potential, and a second terminal of the electrostatic diverting path is connected to the signal output terminal, and
wherein the impedance of the signal transmission path is greater than the impedance of the electrostatic diverting path.

2. The electrostatic protection structure according to claim 1, wherein the signal transmission path comprises a bending section, and the electrostatic diverting path comprises a straight section.

3. The electrostatic protection structure according to claim 2, wherein the bending section comprises a plurality of bending points.

4. The electrostatic protection structure according to claim 1, further comprising at least one electrostatic protection capacitor.

5. The electrostatic protection structure according to claim 4, wherein the at least one electrostatic protection capacitor is provided in the electrostatic diverting path.

6. The electrostatic protection structure according to claim 4, wherein the at least one electrostatic protection capacitor is provided at each of the bending points of the bending section.

7. The electrostatic protection structure according to claim 1, wherein the electrostatic protection structure further comprises a dummy pixel protection unit, and the dummy protection pixel unit is connected between the signal transmission path and the pixel unit.

8. The electrostatic protection structure according to claim 4, wherein one plate of the electrostatic protection capacitor is connected to a constant potential.

9. The electrostatic protection structure according to claim 8, wherein the one plate of the electrostatic protection capacitor is connected to the constant potential via a gate electrode layer.

10. The electrostatic protection structure according to claim 9, wherein
two plates of the electrostatic protection capacitor are respectively formed in a gate electrode layer and a source drain electrode layer, and an intermediate medium of the electrostatic protection capacitor is formed in an active layer; or
two plates of the electrostatic protection capacitor are respectively formed in the source drain electrode layer and a common electrode layer, and the intermediate medium of the electrostatic protection capacitor is formed in a passivation layer.

11. An X-ray image sensor, comprising:
a plurality of pixel units; and
an electrostatic protection structure connected to the pixel units, the electrostatic protection structure comprising:
a data line, adapted to transmit a pixel signal, wherein the data line comprises:
an electrostatic diverting path, and
a signal transmission path,
wherein a first terminal of the signal transmission path is connected to a particular one of the pixel units, and a second terminal of the signal transmission path is connected to a signal output terminal, wherein the second terminal is configured to output a signal from the particular pixel unit,
wherein a first terminal of the electrostatic diverting path is connected to a constant potential, and a second terminal of the electrostatic diverting path is connected to the signal output terminal, and
wherein the impedance of the signal transmission path is greater than the impedance of the electrostatic diverting path.
